(19) United States
(12) Patent Application Publication
(10) Pub. No.: US 2005/0135753 A1
(43) Pub. Date: Jun. 23, 2005

(54) Fibre-optic plug-in connector system

(76) Inventors: Daniel Eigenmann, Herisau (CH); Zullig Marc-Andrew, Arbon (CH)

Correspondence Address: WEBB ZIESENHEIM LOGSDON ORKIN & HANSON, P.C., 700 KOPPERS BUILDING, 436 SEVENTH AVENUE, PITTSBURGH, PA, 15219, US

(21) Appl. No.: 10/507,454

(22) PCT Filed: Jan. 13, 2003
(86) PCT No.: PCT/CH03/00011

(30) Foreign Application Priority Data
Mar. 14, 2002 (CH) 448/02

(51) Int. Cl. G02B 6/38

(52) U.S. Cl. 385/59; 385/71

(57) ABSTRACT

The invention relates to a fibre-optic plug-in connector system (10) comprising an adapter (11), in addition to individual optical plug-in connectors (13), in which a respective optical fibre terminates in a ferrule (23) and which can be respectively inserted into the adapter (11) from two opposing sides to produce an optical connection between the ends of two optical fibres. According to the invention, the adapter (11) has a plurality of parallel guide sheaths (45), which are located next to one another in an adapter housing (12) and into which the optical plug-in connectors (13) comprising their ferrules (23) can be inserted from both sides. To achieve an extremely simple, space-saving construction for a plug-in connector system of this type, the adapter housing (12) is composed of several separate, interconnectable parts (17, 18), between which the guide sheaths (45) are held with a degree of play.

### TECHNICAL FIELD

The present invention relates to the field of fiber-optic connection technology. It concerns a fiber-optic plug-in connector system according to the the preamble of claim 1.

Such a system is known for example from the printed document EP-A2-0 430 107 (FIG. 27 and associated text) or EP-A2-1 168 020.

### PRIOR ART

In the technology of fiber-optic signal transmission, cables in which a plurality of, for example, 12 individual parallel fibers are combined in a cable (known as a ribbon cable) have long been in use. For cables of this type there are special plug-in connector systems, in which all the fibers of the cable are simultaneously connected to one another by a plug-in connector in a predetermined, invariable arrangement. Examples of plug-in connector systems of this type are disclosed in U.S Pat. No. 5,214,730 or in U.S. Pat. No. 6,352,372. The last-mentioned document in particular makes it clear that large-scale integration plug-in connector systems with an extremely high connecting density can be realized in this way.

However, on the other hand there is the desire to connect the individual fibers of such multi-fiber cables to one another or to other fiber-optic single-fiber or multi-fiber cables according to requirements and in a largely freely determinable arrangement. In principle, this is possible using standardized plug-in connector systems with individual plug-in connectors if the fibers of the multi-fiber cable are correspondingly separated at the end of the cable and each individual one is provided with a separate plug-in connector. In the case of a ribbon cable with 12 individual fibers, at the end of the cable there are then for example 12 individual plug-in connectors, which have to be further connected in a plug-in connector system.

In the document cited at the beginning, EP-A2-1 168 020, there is already a description of a plug-in connector system in which a number of individual plug-in connections can be produced independently of one another for multi-fiber cables within a common adapter. The adapter comprises a frame into which a plurality of individual adapter housings of a multi-fiber connector system can be snap-fitted next to one another. However, the combination of a number of individual standardized plug-in connector systems to form an overall system results in an overall system with considerable dimensions, which runs counter to the efforts constantly being made to reduce the size of communication systems.

This also applies to the plug-in connector system shown in FIG. 27 of EP-A2-0 430 107, in which a plurality of slots are arranged next to one another in a one-part adapter housing for the separate connection to standardized plug-in connectors which are provided with a relatively large housing. With a plug-in connector system for separately connecting the fibers of a multi-fiber cable comprising 12 fibers, this produces an arrangement which takes up considerable space and therefore cannot be used in practice for this purpose. Disadvantages are also brought about by the locking system accommodated in the adapter housing, which leads to a significant increase in the overall height.

In an earlier patent application of the applicant (WO-A1-01/59499), multiple plug-in connector systems in which very narrow individual plug-in connector inserts are combined in a common housing to form a multiple plug-in connector have already been proposed for use in backplane connections. That application does not envisage freely determinable plug-in connection between individual plug-in connector inserts.

### SUMMARY OF THE INVENTION

It is therefore the object of the invention to provide a fiber-optic plug-in connector system which is distinguished by an extremely compact arrangement and in particular a low overall height, and which makes it possible for a multiplicity of individual fibers to be connected according to choice in an extremely small space while at the same time being easy to handle.

The object is achieved by the features of claim 1 in their entirety. The essence of the invention is to achieve a low overall height and at the same time a high connector density by a multi-part adapter housing in which the guiding sleeves necessary for the plug-in connection are held directly between the housing parts.

The plug-in connector system is particularly simple and space-saving if, according to a preferred refinement of the invention, the adapter housing is made up of a flat, plate-shaped upper part and a flat, plate-shaped lower part.

The correct assembly of the multipart adapter housing is facilitated by guiding means being provided on the upper part and/or the lower part for aligning the two parts with each other, the guiding means preferably comprising a number of guiding pins which are arranged in a distributed manner, are attached in one of the parts and enter into a corresponding bore in the other part.

Assembly is further simplified and improved by connecting means which comprise screw couplings in particular being provided for releasably connecting the upper part and the lower part. This allows the system to be easily dismantled again if need be for maintenance or repair purposes.

According to another preferred refinement of the invention, respectively provided in the upper part and the lower part is a central web, which runs transversely in relation to the plugging direction and has a plurality of half-cylindrical depressions for receiving the guiding sleeves, arranged one behind the other in the longitudinal direction of the central web. Also respectively provided in the upper part and the lower part, in front of and behind the central web in the plugging direction, are guiding rails, which run between the guiding sleeves in the plugging direction and define for each of the guiding sleeves an associated insertion channel for a plug-in connector.

Possibilities for flexible use of the plug-in connector system are achieved by means for fastening and/or aligning the adapter housing being provided on the adapter housing.

An optimal combination of good operating suitability and a high connection density is obtained in particular if the spacing of the guiding sleeves arranged directly next to one another, measured from sleeve axis to sleeve axis, is approximately twice the inside diameter of the guiding sleeves. It is also of advantage in this connection if the ferrules used in the plug-in connectors have an outside diameter of 1.25 mm.

Also essential for the compact construction of the plug-in connector system is the configuration of the individual plug-in connectors. A preferred refinement of the invention is characterized in that the plug-in connectors respectively have a holder, preferably consisting of a plastic, in the form of a rectangular frame, which is elongate in the plugging direction, encloses an interior space and in the front side of which an opening for the ferrule and in the rear side of which a through-bore for leading through a fiber-optic cable are provided, in that a spring element, in particular in the form of a spiral spring, is mounted in the interior space of the holder for the sprung-mounting of the ferrule, and in that the opening for the ferrule is formed such that it is open toward the side to facilitate assembly.

To provide the possibility of adjustment of the optical fiber in the plug-in connector, the ferrule is preferably inserted in an inner part, preferably consisting of metal, arranged in the interior space of the holder, the inner part has a guiding sleeve for guiding the spring element, and means which permit an adjustment of the inner part into different angular positions by rotation about its longitudinal axis are provided on the inner part, the adjusting means comprising in particular an adjusting portion with a square cross section, which adjoins the guiding sleeve in the front region of the inner part and has a receiving bore for receiving the ferrule, and on which the spring element is supported by its front end.

The securing of the plug-in connections is preferably made possible by a side wall on the holders respectively having a resilient portion with a latching element arranged on it, and by latching openings into which the plug-in connectors engage with their latching elements on insertion in the adapter housing being provided in the adapter housing.

To facilitate use of the plug-in connector system, it may be of advantage if the guiding sleeves in the adapter are combined into a number of groups, respectively comprising a number of guiding sleeves. With a total of 12 individual plug-in connections, it is of advantage if two groups of six guiding sleeves each are provided in the adapter.

Further embodiments emerge from the dependent claims.

### BRIEF EXPLANATION OF THE FIGURES

The invention is to be explained in more detail below on the basis of exemplary embodiments in conjunction with the drawing, in which

FIG. 1 shows in a perspective side view a fiber-optic plug-in connector system according to a preferred exemplary embodiment of the invention for the individual connection of a total of 12 fibers in two groups of 6 fibers each;

FIG. 2 shows the adapter of the plug-in connector system from FIG. 1 in an exploded representation;

FIG. 3 shows the adapter in the representation according to FIG. 2 with the associated plug-in connectors in the partially inserted state;

FIG. 4 shows an individual plug-in connector from FIG. 3 in an exploded representation; and

FIG. 5 shows the adapter from FIG. 1 in the view from the front and in the plan view from above.

### WAYS OF IMPLEMENTING THE INVENTION

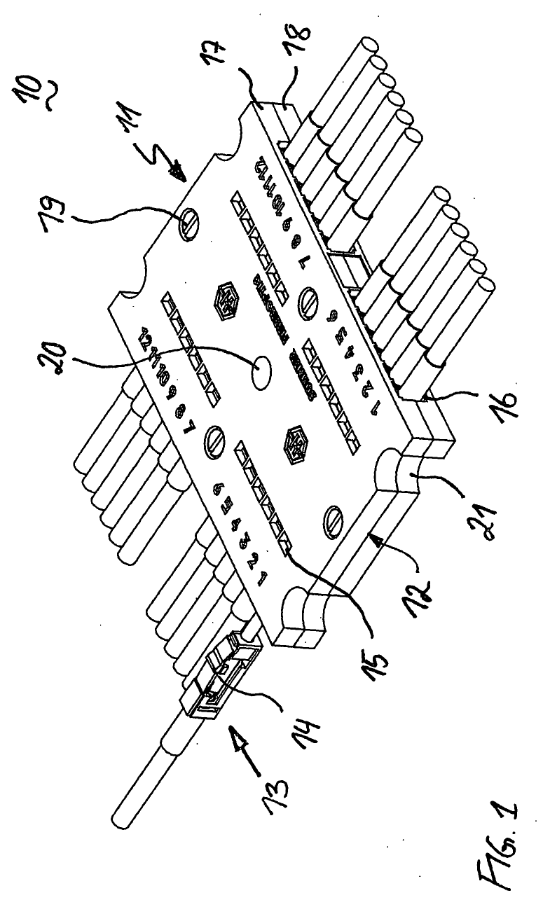

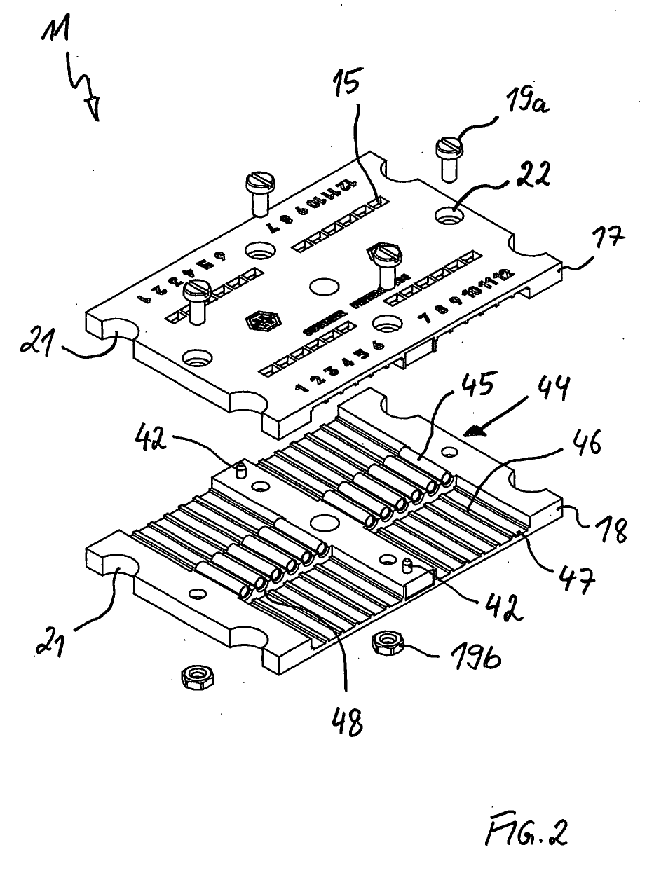

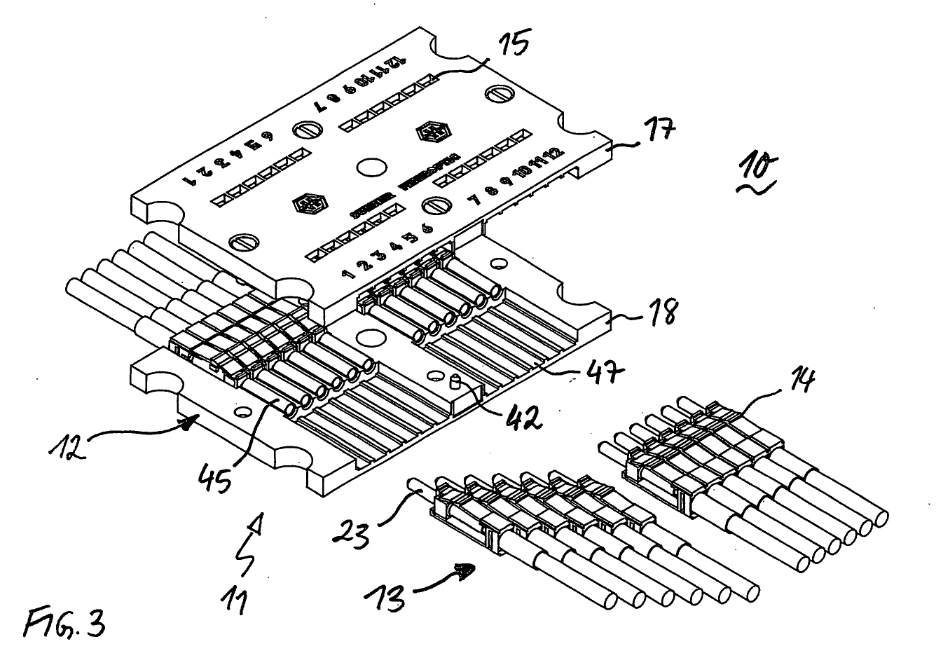

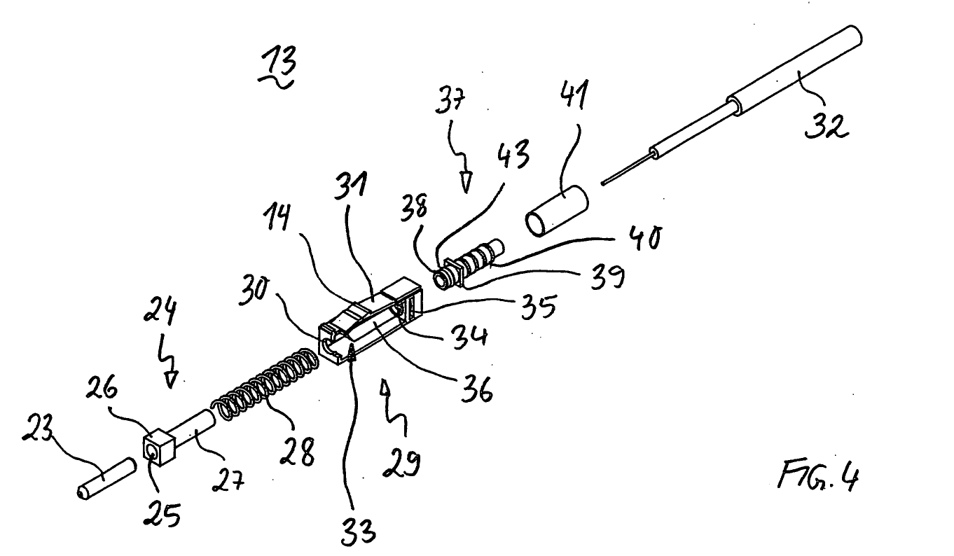

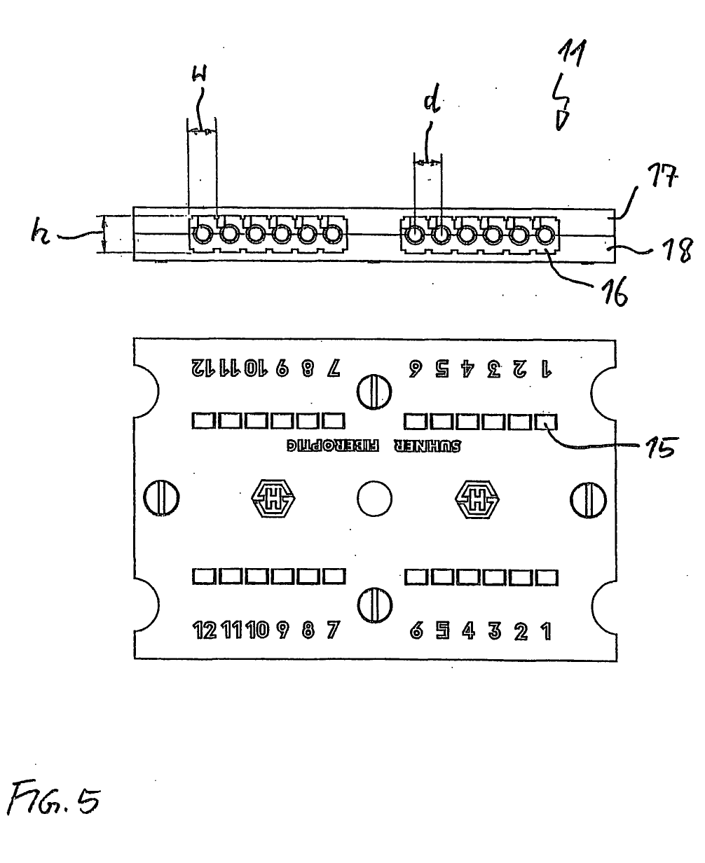

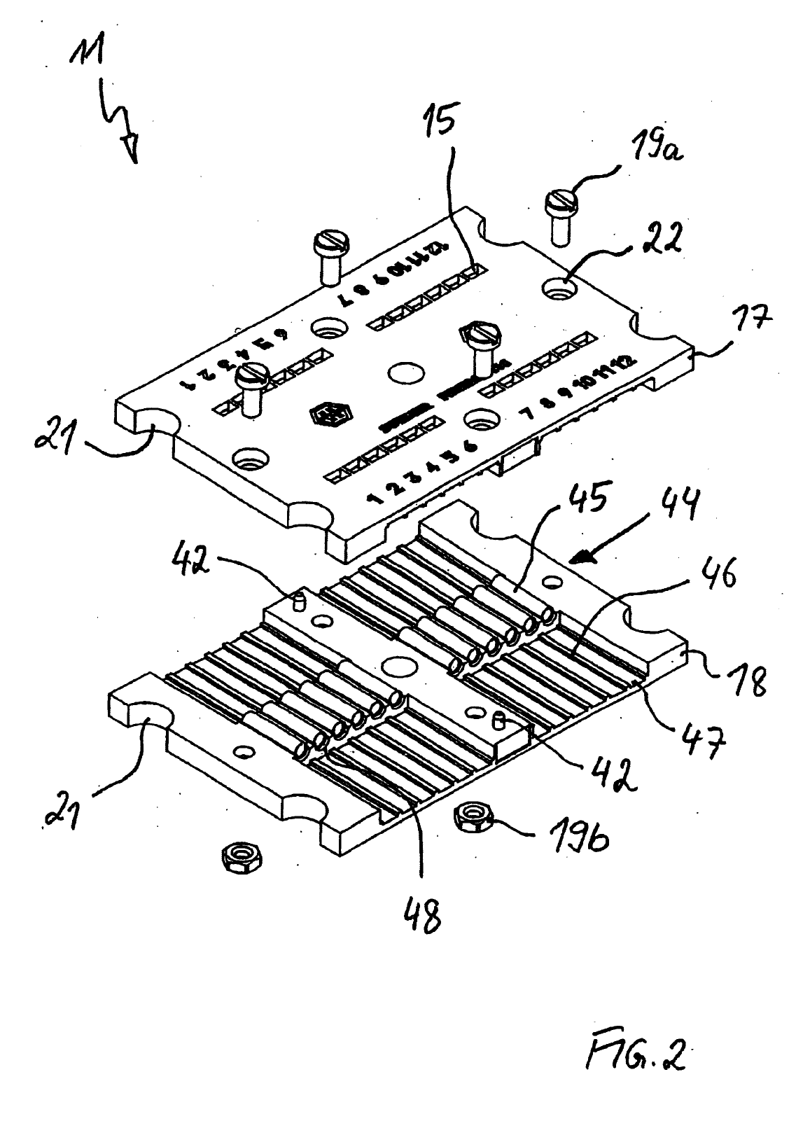

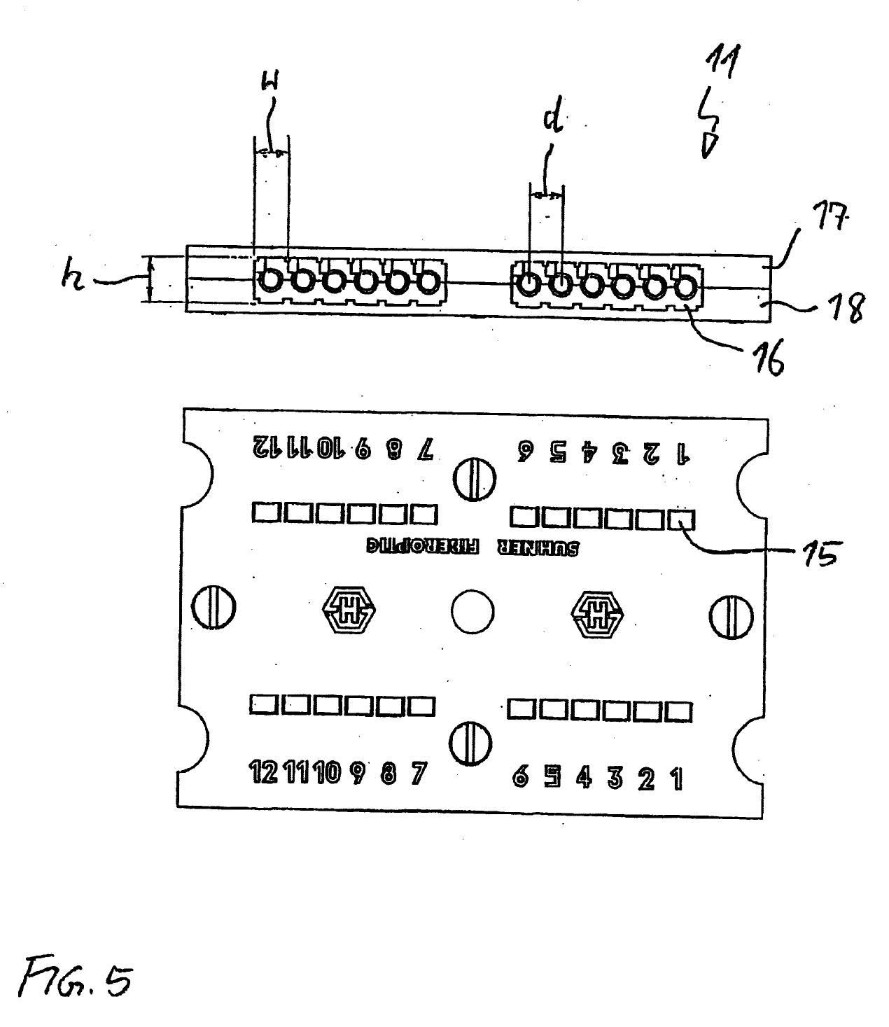

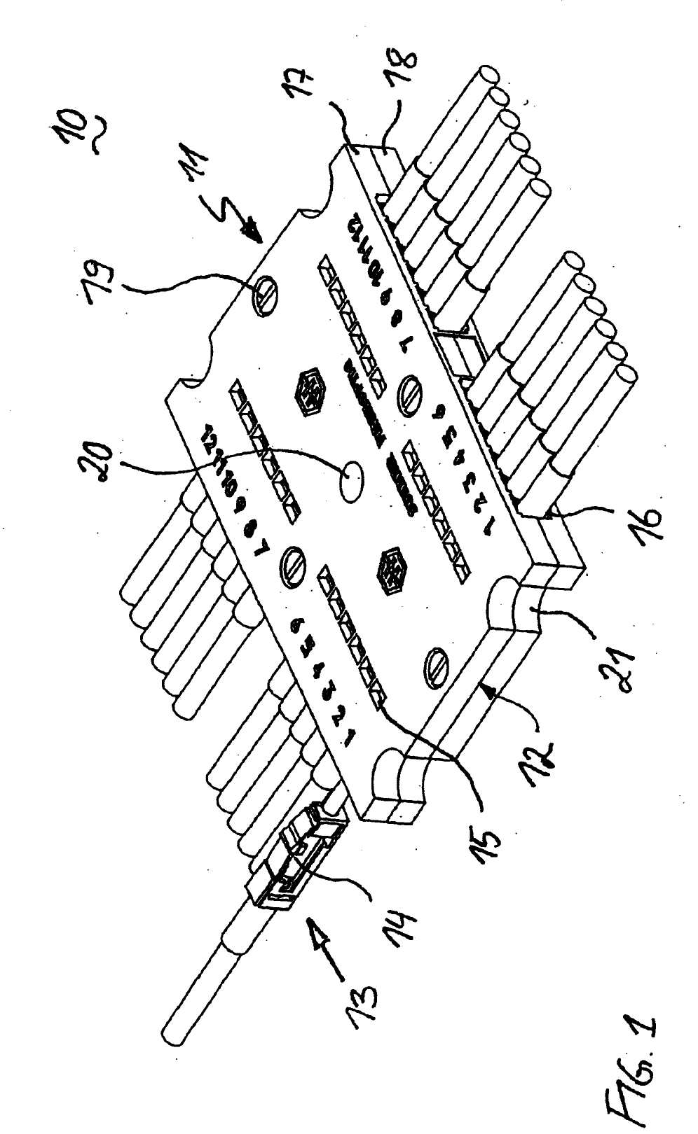

In FIG. 1, a fiber-optic plug-in connector system according to a preferred exemplary embodiment of the invention is represented in a perspective side view. The fiber-optic plug-in connector system 10 comprises an adapter 11, which has a rectangular, flat adapter housing 12 comprising an upper part 17 and a lower part 18. Respectively arranged on the opposite longitudinal sides of the adapter 11 are two rows of insertion openings 16 lying directly next to one another (see also FIG. 5, upper part-figure). In the example represented, there are in each case 6 insertion openings 16 per row, that is a total of 12 insertion openings 16. For better identification and differentiation of the individual insertion openings 16, associated numbers 1 . . . 12 have been applied to the upper side of the adapter housing 12. Each of the insertion openings 16 is assigned an insertion channel (47 in FIG. 2), running inside the adapter housing 12. Every two insertion openings 16 and insertion channels 47 lying directly opposite one another respectively form a pair, which can be used for connecting two optical fibers. For this purpose, the optical fibers are respectively provided at their ends. with a plug-in connector 13 made to match the adapter 11. With the adapter represented in FIG. 1, a maximum of 12 pairs of optical fibers can be connected to one another according to choice, for which purpose a total of at most 24 plug-in connectors 13 shown in FIG. 1 are required (23 plug-in connectors are shown in the inserted state in FIG. 1, 1 plug-in connector at position 1 is shown pulled out).

The two parts 17 and 18 of the adapter housing are releasably connected to each other by a number of screw couplings 19. The screw couplings 19 preferably each comprise a screw (19a in FIG. 2) and a nut (19b in FIG. 2). Screw heads and nuts are countersunk on the adapter housing 12 in corresponding screw holes (22 in FIG. 2). In order that the adapter 11 can be fastened on an underlying surface (rear wall, printed circuit board or the like), a fastening hole 20 passing through the adapter housing 12 is provided in the middle. At the same time, the adapter housing 12 has on its transverse sides semicircular recesses, which can be used for positioning and/or fastening.

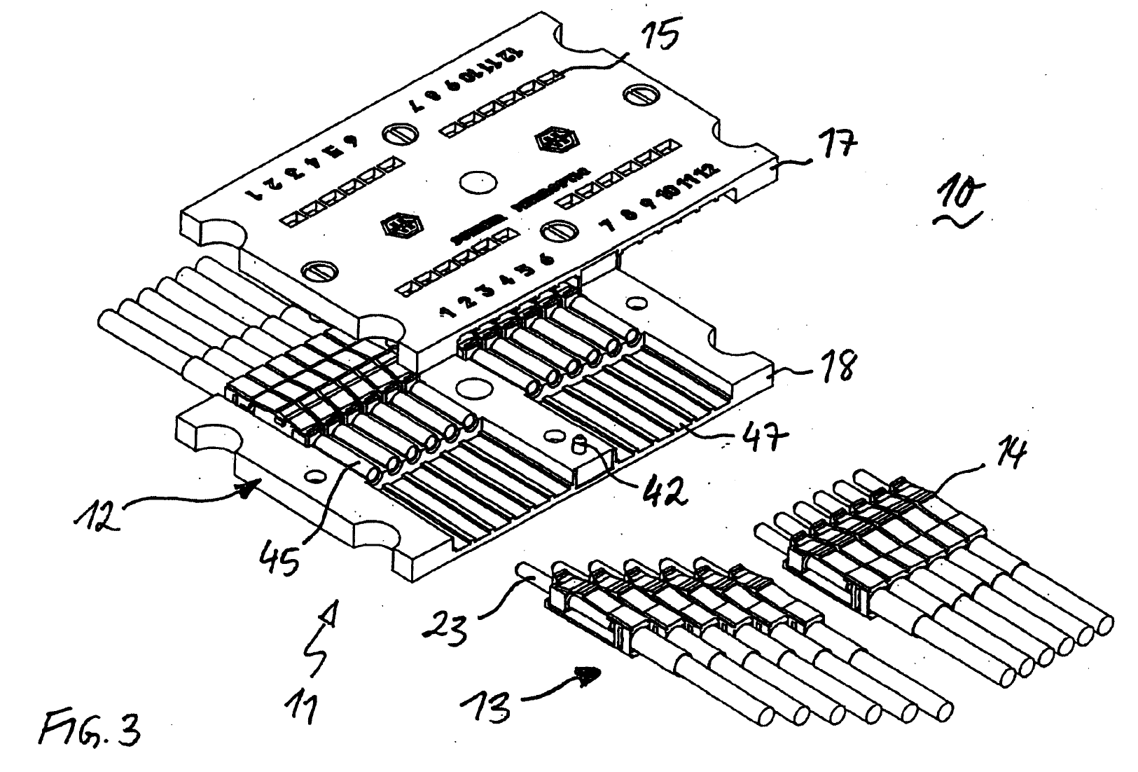

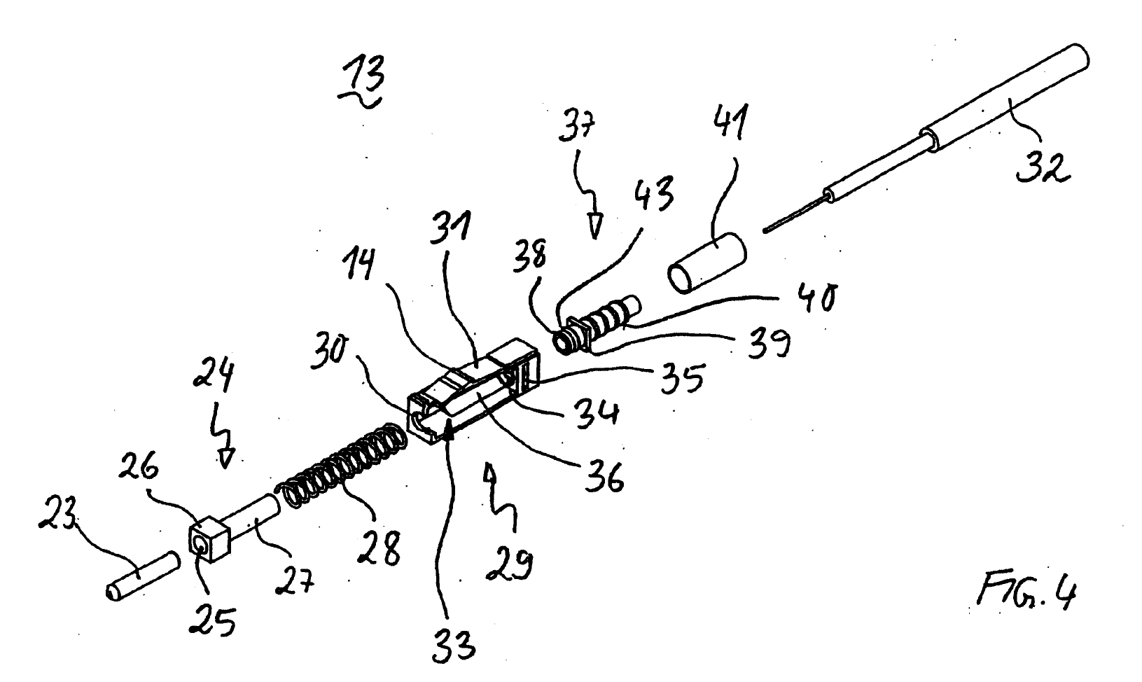

The internal construction of the adapter 11 is reproduced in the exploded representation of FIG. 2. Central elements of the adapter 11 are a plurality of cylindrical guiding sleeves 45, of which there is one per plug-in connection, that is a total of 12. The guiding sleeves 45 receive the ferrules (23 in FIGS. 3, 4) of the plug-in connectors 13 in a way known per se and guide them in such a way that the ferrules of the two plug-in connectors involved in the plug-in connection and the ends of the fibers that are located in the central bores of the ferrules butt against one another with the end faces.

The mounting of the guiding sleeves 45 takes place directly in the parts 17 and 18 of the adapter housing 12. For this purpose, in the upper part 17 and the lower part 18 there is respectively formed a central web 44, which runs in the longitudinal direction and in which there are formed two rows of parallel, half-cylindrical depressions 48, arranged one behind the other in the longitudinal direction and running in the plugging direction. In the trough-like depressions 48, which complement one another to form a cylindrical bore when the upper part 17 and the lower part 18 are screwed together, the guiding sleeves 45 are mounted and held with a degree of play. In order that the two parts 17, 18 of the adapter housing 12 can be placed one on top of the other with the precision necessary for the mounting of the guiding sleeves 45, arranged on the upper side of the lower part 18 are two widely spaced-apart guiding pins 42, which enter into corresponding bores on the underside of the upper part 17 and in this way align the two parts 17, 18 with each other.

The upper part 17 and the lower part 18 are two flat plates of the same height, which are formed substantially mirror-symmetrically in relation to a central plane. The overall height of the adapter housing 12 is in this case no more than approximately 5 mm. Respectively provided in the upper part 17 and in the lower part 18, in front of and behind the central web 44 in the plugging direction, in a lower-lying plane, are guiding rails 46, which run between the guiding sleeves 45 in the plugging direction. Every two guiding rails 46 neighboring a guiding sleeve 45 define an insertion channel 47 for a plug-in connector 13, associated with the guiding sleeve.

The plug-in connectors can be inserted into the insertion channels 47 formed in this way—as represented in FIG. 3, their ferrules 23 being received by the associated guiding sleeves 45. Since each individual one of the 12 plug-in connections on each side of the guiding sleeve 45 has an insertion channel of its own, the 12 plug-in connections can be made completely independently of one another, as indicated by the plug-in connectors 13 depicted in offset arrangement in FIG. 3. In order that the plug-in connectors 13 are securely held in the adapter 11 in the inserted state, a latching device is provided for each plug-in connector, comprising according to FIG. 1 a resilient latching element 14 in the form of a latching stage on the plug-in connector 13, with which the plug-in connector 13 engages in a latching opening 15 in the upper part 17 of the adapter housing 12 in the inserted state. For releasing the latching engagement, the latching element 14 can be pressed with a suitable object or implement downward from above through the latching openings 15, and the plug-in connector 13 at the same time lifted out of the insertion channel 47.

The particularly compact and space-saving construction of the plug-in connector system 10, and in particular of the adapter 11, is only possible if the plug-in connectors 13 themselves are restricted to a minimum in their outer dimensions. Used with preference as plug-in connector 13 in the present case is a configuration which has already been used by the applicant in an earlier application (WO-A1-01/59499) in a different context, that is as an insert in a backplane connector. The construction of the plug-in connector 13 is reproduced in an exploded representation in FIG. 4.

According to FIG. 3, an individual plug-in connector 13 comprises the ferrule 23 (material: for example zirconia; diameter: preferably 1.25 mm), an inner part 24 (made of metal), a spring element 28 in the form of a spiral spring, a frame-shaped holder 29 (injection molding made of plastic), a crimping neck 37 (made of metal) and a crimping sleeve 41 (likewise made of metal). It goes without saying that, instead of the spiral spring, some other spring element, for example a rubber tube, may also be used. The holder 29 forms the basic component of the plug-in connector 13 and gives the plug-in connector 13 the necessary mechanical stability. The other components 23, 24, 28, 37 and 41 are accommodated in the holder 29 or attached to the holder 29. The holder 29 has the form of a rectangular frame which is elongate in the plugging direction and encloses an interior space 33. In the front wall (front side) of the frame, an opening 30 is provided for the ferrule 23. In the rear wall (rear side), a through-bore 34 is provided for leading through the fiber-optic cable 32, and a rectangular receiving space 35 is provided. Arranged on the outer side of the rear wall is a square recess (not visible in FIG. 3).

The crimping neck 37 comprises a square holding plate 39, which is respectively adjoined at the front and rear in the axial direction by a tube stub 38 and 40. The front tube stub 38 additionally bears a concentric annular bead 43. When the crimping neck 37 is pressed into the through-bore 34 of the holder 29, the tube piece 38 engages with its annular bead 43 in the receiving space 35. At the same time, the holding plate 39 comes to lie in the aforementioned recess in the rear wall and in this way secures the crimping neck 37, pressed into the holder 29, against being twisted by a torsional force acting. on the cable 32. The front tube stub 38, protruding into the interior space 33 when the crimping neck 37 is pressed in, serves for supporting the spiral spring 28 inserted into the interior space 33. The rear tube stub 40, protruding out of the holder 29 to the rear, serves for securing the strain relief of the fiber-optic cable 32 by means of the crimping sleeve 41 pushed over it and subsequently pressed.

The ferrule 23, the inner part 24 and the spiral spring 28 are mounted in the interior space 33 of the holder 29. The inner part 24 comprises a guiding sleeve 27 for guiding the spiral spring 28 and an adjusting portion 26 with a square cross section. The adjusting portion 26 adjoins the guiding sleeve 27 in the front region of the inner part 24 and has a receiving bore 25 for receiving the ferrule 23. The spiral spring 28, pulled over the guiding sleeve 27, is supported by its front end against the rear side of the adjusting portion 26. The ferrule 23 is pressed into the receiving bore 25 on the inner part 24 and inserted together with the inner part 24 and the pushed-on spiral spring 28 into the interior space 33 from the open side of the holder. In order that the ferrule 23 can assume its place in the front opening 30 unhindered, this opening 30 is formed such that it is open to the side. The interaction-between the square adjusting portion 26 and the rectangular interior space 33 permits an adjustment of the inner part 24 (or the fiber) into different angular positions by rotation about its longitudinal axis (in 4 steps of 90° each). The spiral spring 28 thereby presses the inner part against the front part of the holder 29, so that the adjusted position can be held. In order to give the spiral spring 28 an additional lateral hold in the interior space 33, elongate bounding elements 36 may be formed on the inner side of the longitudinal walls of the holder.

However, instead of the rectangular or square configuration with its adjustability in steps of 90°, it is also conceivable for example to provide a hexagonal configuration with an adjustability in steps of 60°. In order that the plug-in connectors 13 can be inserted into the adapter 11 with latching engagement, on each holder 29 the upper-lying side wall respectively has a resilient portion 31, protruding outward in a slightly V-shaped manner, arranged on which is a latching stage (latching element 14), which as already described further above—releasably engages in the associated latching opening 15 on the adapter housing 12 when the plug-in connector 13 is pushed in.

The high plug-in connector density that is possible with the solution according to the invention can be seen from the front view in the upper part of FIG. 5, showing the height h and the width w of an an individual insertion opening 16 and the spacing d between two neighboring guiding sleeves or insertion openings 16, measured from sleeve axis to sleeve axis. If ferrules 23 with a diameter of 1.25 mm are used, each plug-in connector 13 or each insertion opening 16 has dimensions (width×height) with a width w of approximately 2.4 mm and a height h of approximately 3.4 mm. The spacing d is then approximately the same size as the width w.

For comparison, the corresponding dimensions of known plug-in connectors are given below:

| Plug-in connector type | Width × height (mm × mm) |
|---|---|
| Pres. appl. (1.25 mm ferrule) | 2.4 × 3.4 |
| LC connector (1.25 mm ferrule) | 4.5 × 9.1 |
| sc connector (2.5 mm ferrule) | 7.4 × 9.0 |
| LSH connector (2.5 mm ferrule) | 6.7 × 12 |

It is immediately evident from the comparison that, with the plug-in connector system according to the application, a considerably more compact solution is available for complex and flexible connections of optical fibers.

### LIST OF DESIGNATIONS

10 fiber-optic plug-in connector system
11 adapter
12 adapter housing
13 optical plug-in connector
14 latching element (latching stage)
15 latching opening
16 insertion opening
17 upper part
18 lower part
19 screw coupling
19a screw
19b nut
20 fastening hole
21 recess
22 screw hole
23 ferrule
24 inner part
25 receiving bore
26 adjusting portion
27 guiding sleeve
28 spring element or spiral spring
29 holder (frame-shaped)
30 opening
31 resilient portion
32 fiber-optic cable
33 interior space
34 through-bore
35 receiving space (rectangular)
36 bounding element
37 crimping neck
38,40 tube stub
39 holding plate
41 crimping sleeve
42 guiding pin
43 annular bead
44 central web
45 guiding sleeve
46 guiding rail
47 insertion channel
48 depression (half-cylindrical)
d spacing
h height
w width

1. A fiber-optic plug-in connector system (10), comprising an adapter (31) and individual optical plug-in connectors (13), in which an optical fiber respectively ends in a ferrule (23), and which can be respectively inserted into the adapter (11) from two opposing sides to produce an optical connection between the ends of two optical fibers, the adapter (11) having in an adapter housing (12) a plurality of guiding sleeves (45), which are arranged parallel next to. one another and into which the optical plug-in connectors (13) can be inserted with their ferrules (23) from both sides, characterized in that the adapter housing (12) is made up of a number of separate parts (17, 18) which can be connected to one another and between which the guiding sleeves (45) are held with a degree of play.

2. The plug-in connector system as claimed in claim 1, characterized in that the adapter housing (12) is made up of a flat, plate-shaped upper part (17) and a flat, plate-shaped lower part (18).

3. The plug-in connector system as claimed in claim 2, characterized in that guiding means (42) are provided on the upper part (17) and/or the lower part (18) for aligning the two parts (17, 18) with each other.

4. The plug-in connector system as claimed in claim 3, characterized in that the guiding means comprise a number of guiding pins (42) which are arranged in a distributed manner, are attached in one of the parts (17, 18) and enter into a corresponding bore in the other part.

5. The plug-in connector system as claimed in one of claims 2 to 4, characterized in that connecting means (19; 19a,b; 22) are provided for releasably connecting the upper part (17) and the lower part (18).

6. The plug-in connector system as claimed in claim 5, characterized in that the connecting means comprise screw couplings (19).

7. The plug-in connector system as claimed in one of claims 2 to 6, characterized in that respectively provided in the upper part (17) and the lower part (18) is a central web (44), which runs transversely in relation to the plugging direction and has a plurality of half-cylindrical depressions (48) for receiving the guiding sleeves (45), arranged one behind the other in the longitudinal direction of the central web (44).

8. The plug-in connector system as claimed in claim 7, characterized in that respectively provided in the upper part (17) and the lower part (18), in front of and behind the central web (44) in the plugging direction, are guiding rails (46), which run between the guiding sleeves (45) in the plugging direction and define for each of the guiding sleeves (45) an associated insertion channel (47) for a plug-in connector (13).

9. The plug-in connector system as claimed in one of claims 1 to 8, characterized in that means (20, 21) for fastening and/or aligning the adapter housing (11) are provided on the adapter housing (11).

10. The plug-in connector system as claimed in one of claims 1 to 9, characterized in that the spacing (d) of the guiding sleeves (45) arranged directly next to one another, measured from sleeve axis to sleeve axis, is approximately twice the inside diameter of the guiding sleeves (45).

11. The plug-in connector system as claimed in one of claims 1 to 10, characterized in that the ferrules (23) have an outside diameter of 1.25 mm.

12. The plug-in connector system as claimed in one of claims 1 to 11, characterized in that the plug-in connectors (13) respectively have a holder (29), preferably consisting of a plastic, in the form of a rectangular frame, which is elongate in the plugging direction, encloses an interior space (33) and in the front side of which an opening (30) for the ferrule (23) and in the rear side of which a through-bore (34) for leading through a fiber-optic cable (32) are provided, and in that a spring element (28), in particular in the form of a spiral spring, is mounted in the interior space (33) of the holder for the sprung-mounting of the ferrule (23).

13. The plug-in connector system as claimed in claim 12, characterized in that the opening (30) for the ferrule (23) is formed such that it is open toward the side to facilitate assembly.

14. The plug-in connector system as claimed in claim 12, characterized in that the ferrule (23) is inserted in an inner part (24) preferably consisting of metal, arranged in the interior space (33) of the holder (29), in that the inner part (24) has a guiding sleeve (27) for guiding the spring element (28), and in that means (26) which permit an adjustment of the inner part (24) into different angular positions by rotation about its longitudinal axis are provided on the inner part.

15. The plug-in connector system as claimed in claim 14, characterized in that the adjusting means comprise an adjusting portion (26) with a square cross section, which adjoins the guiding sleeve (27) in the front region of the inner part (24) and has a receiving bore (25) for receiving the ferrule (23), and on which the spring element (28) is supported by its front end.

16. The plug-in connector system as claimed in one of claims 12 to 15, characterized in that a side wall on the holders (29 respectively has a resilient portion (31) with a latching element (14) arranged on it, and in that latching openings (15) into which the plug-in connectors (13) engage with their latching elements (14) on insertion in the adapter housing (12) are provided in the adapter housing (12).

17. The plug-in connector system as claimed in one of claims 12 to 16, characterized in that for fastening the fiber-optic cable (32), provided on the holder (29) is a crimping neck (37), which preferably consists of a metal, can be pressed with a snap fit into the through-bore (34) of the holder (29) and has a tube stub (40) protruding out of the holder (29) to the rear for the fastening of a crimping sleeve (41).

18. The plug-in connector system as claimed in one of claims 1 to 17, characterized in that the guiding sleeves (45) in the adapter (11) are combined into a number of groups, respectively comprising a number of guiding sleeves.

19. The plug-in connector system as claimed in claim 18, characterized in that two groups of six guiding sleeves (45) each are provided in the adapter (11).

20. The plug-in connector system as claimed in one of claims 1 to 19, characterized in that each plug-in connector (13) in the adapter (11) can be inserted into a rectangular insertion opening (16) with a width (w) of approximately 2.4 mm and a height (h) of approximately 3.4 mm.
